(19) United States
(12) Patent Application Publication
(10) Pub. No.: US 2011/0159935 A1
(43) Pub. Date: Jun. 30, 2011

(54) FLEXIBLE ATTACHMENT DEVICE FOR MOBILE GADGETS

(76) Inventor: Erez Eric Gavara, Miami, FL (US)

(21) Appl. No.: 12/649,526

(22) Filed: Dec. 30, 2009

(51) Int. Cl. H04M 1/00

(52) U.S. Cl. 455/575.6

(57) ABSTRACT

The technology comprises an attachment device further comprising a piece of elastic material made out of PVC and plasticizer that defines the circumference of a thru-cavity and a base. Wherein the base bonds to a mobile gadget's surface through a solvent-based adhesive creating a monolithic structure. Wherein the attachment device is used to secure mobile gadgets or to secure identifying charms by engaging cords, metal rings, strings, thin ropes, hooks, chains, chain links and key-rings. The technology further comprises a method to secure mobile gadgets comprising using a piece of elastic material. The piece of elastic material defines the circumference of a thru-cavity and a base. By mating the base on to the surface of a mobile gadget and using a solvent-based adhesive to bond to a mobile gadget's surface creating a monolithic structure with the base.

### FIELD OF THE INVENTION

The present invention relates to mobile gadget attachment devices.

### CROSS REFERENCE TO RELATED APPLICATIONS

Not applicable.

### STATEMENT REGARDING FEDERALLY-SPONSORED RESEARCH AND DEVELOPMENT

Not applicable.

### BACKGROUND OF THE TECHNOLOGY

In 2007, there will be 8 million phones lost, including 700,000 smart phones. Any of these, particularly the smart phones, is a corporate data security breach waiting to happen and make headlines. More than half a million people who just purchased a mobile smartphone such as iPhones, will loose their personal data, along with the phone. Losing a cell phone or a smart phone loaded with invaluable contacts, calendars, e-mails and client data is a severe blow to their business and personal lives.

Unfortunately, many individuals and businesses do not consider the ramifications of these losses until it is too late. In many cases, this upset can be avoided by simply attaching the hardware to a chain like assembly that is fastened to the user's clothing.

One of the issues with these attachments is that they get unfastened with ease. The user will get a false sense of security when carrying their mobile devices just because it is attached to a chain and to their clothes. The issue with this assembly is that the current attachments are bonded by a thermosetting adhesive or glue. This glue wears off and loses strength over time. Simultaneously, the shear forces make the interface between the phone and the glued attachment device very weak.

The second issue is that the current attachments are not made for the modern curved phone styles such as the iphone for example. The latest phones have rounded corners and it is very difficult for the current attachment methods to hold a chain in place, and is usually detached by its own weight since most modern cell phone are heavy. Most attachment methods today are rigid or are made out of metal or other rigid materials. The rigidity in the attachment boundary between the adhesive and the phone is very vulnerable to shear forces as the mobile device is used.

There is nothing in the mobile device attachment arts that accommodates for the curved and complex shapes of modern mobile devices. There is also a need in the industry to move from rigid attachment devices to a flexible solution that contours around the curves of modern mobile phones. Moreover, it is desirable to progress from adhesive-tape, or glue, to an attachment system that becomes built into the structure of the mobile device in order to avoid loosing the mobile device.

### BRIEF SUMMARY OF THE INVENTION

The present invention provides for a mobile gadget attachment device that is flexible.

### BRIEF DESCRIPTION OF THE SEVERAL VIEWS OF THE DRAWINGS

The foregoing summary, as well as the following detailed description of the technology, will be better understood when read in conjunction with the appended drawings. For illustrating the technology, the drawings are shown in the embodiments that are presently preferred. It should be understood, however, that the technology is not limited to the precise arrangements and instrumentalities shown. In the drawings:

FIG. 1 depicts an embodiment of the technology, where it shows a cross-section as seen from above of the attachment device.

FIG. 2 depicts an embodiment of the technology, where it shows a side view of the attachment device further comprising a device not cut until the end.

FIG. 3 depicts an embodiment of the technology, where it shows a side view cross-section of one of the preferred embodiments.

FIG. 4 depicts an embodiment of the technology, where it shows the technology as it is used, it further depicts the base.

FIG. 5 depicts an embodiment of the technology, where it shows a top view a technology is used as it is attached to a mobile device.

FIG. 6 depicts an embodiment of the technology, where it shows a side view where the technology is used as it is attached to an iphone.

FIG. 7 depicts an embodiment of the technology, where it shows a side view where the technology is used as it is attached to another mobile device.

FIG. 8 depicts an embodiment of the technology, where it shows a side view where the technology is used as it is attached to yet another mobile device.

FIG. 9 depicts an embodiment of the technology, where it shows a top view of technology.

FIG. 10 depicts an embodiment of the technology, where it shows a side view of technology.

FIG. 11A depicts an embodiment of the technology, where it shows a side view of technology as it is attached to mobile device using the solvent-based adhesive.

FIG. 11B depicts an embodiment of the technology, where it shows a side view of technology as it is attached to mobile device using the solvent-based adhesive as it dissolves the shell of the mobile device.

FIG. 11C depicts an embodiment of the technology, where it shows a side view of technology as it is attached to mobile device using the solvent-based adhesive as it creates a monolithic structure.

FIG. 12 depicts a photograph of the technology as used.

### DESCRIPTION OF THE TECHNOLOGY

The present technology depicts an inventive solution to the fore mentioned issues related to mobile phone attachments.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art. As appropriate, procedures involving the use of commercially available kits and reagents are generally carried out in accordance with manufacturer defined protocols and/or parameters unless otherwise noted.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

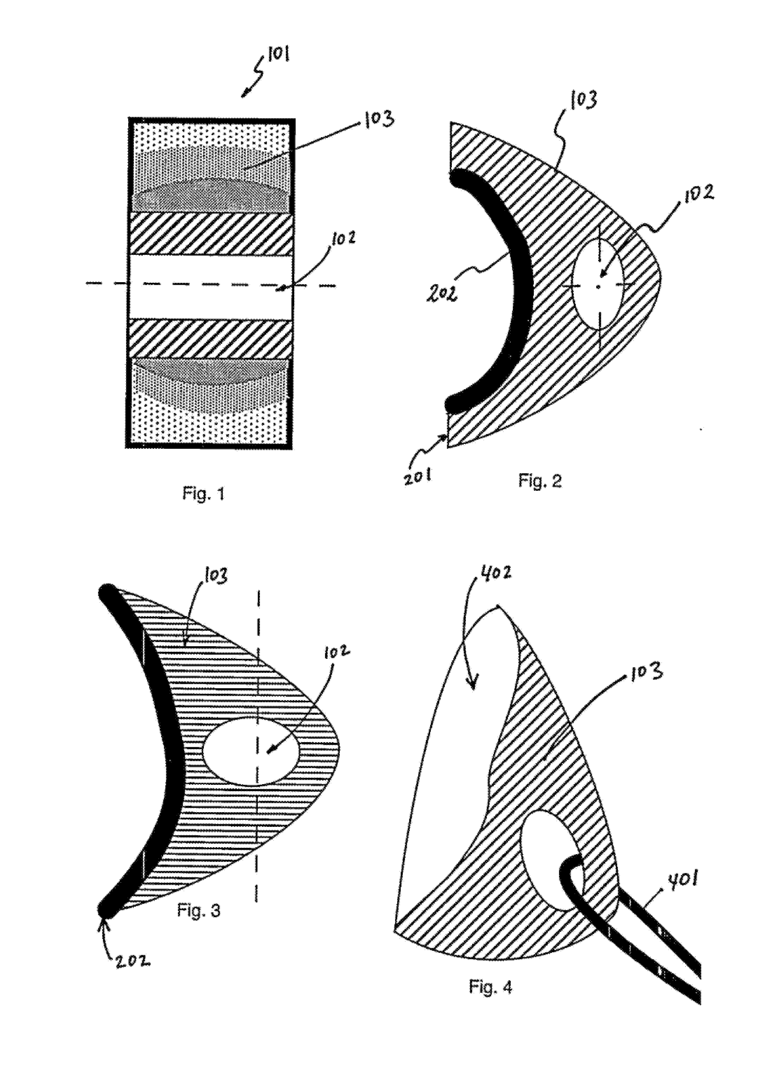

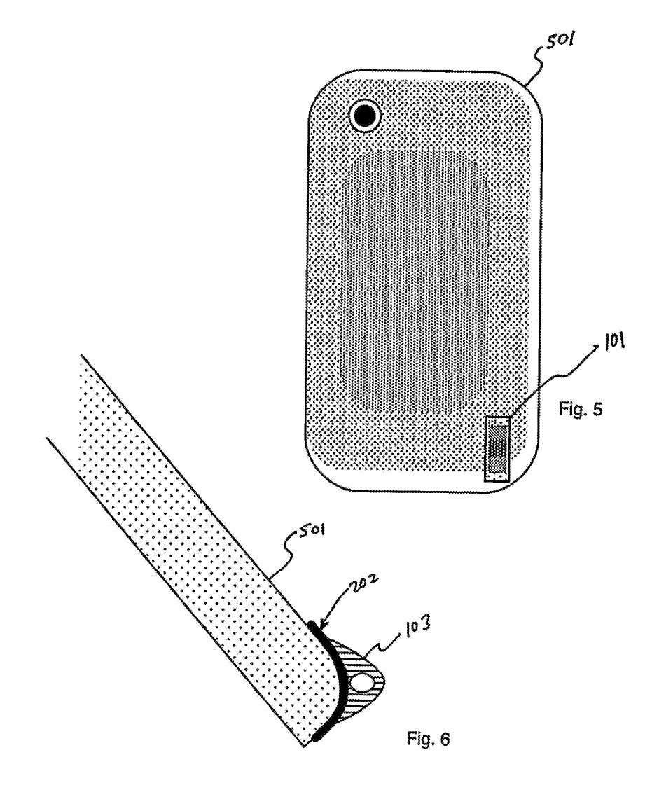

As depicted in FIG. 1, FIG. 2, FIG. 3, and FIG. 4 the technology pertains to an attachment device 101 that contains a thru-cavity 102 that engages at least one fastener 401. This string or thin rope could be made of several strands braided, twisted, or woven together, a long ropelike, chain, chain links, a key-ring, as a secondary means to safe guard at least one mobile device or gadget. This chain or rope is ultimately tied to the user's clothes by means of a clip or similar spring fastening device.

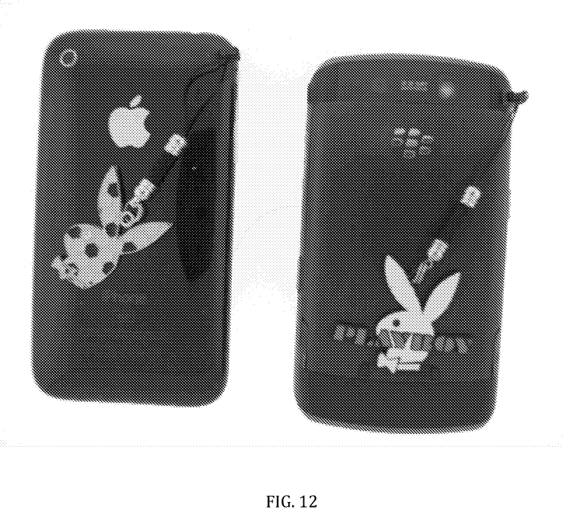

The technology described herein helps mobile gadget users identify their look-a-like mobile gadgets by providing a method to attach identifying charms or objects as seen in FIG. 12. Users may encounter situations where several mobile gadgets are placed together such as airports, crowded places, and court houses entrances and identifying your own is critical. Another advantage in using the technology is that when is connected to the body of the user through a key chain or the like, the user can surely rely on the attachment device herein holding on securely to the valuable mobile gadget.

The attachment device herein comprises a solid piece of elastic material 103, at least one thru-cavity 102, at least one base 402, and at least one solvent-based adhesive 202; wherein said solvent-based adhesive 202 dissolves at least one molecular chain in the elastic material and the surface of the mobile device to create a monolithic structure attachment. Monolithic structure comprises a bond that consisting of one piece; solid or unbroken bond between the attachment device herein 103 and the mobile device's exterior shell 501.

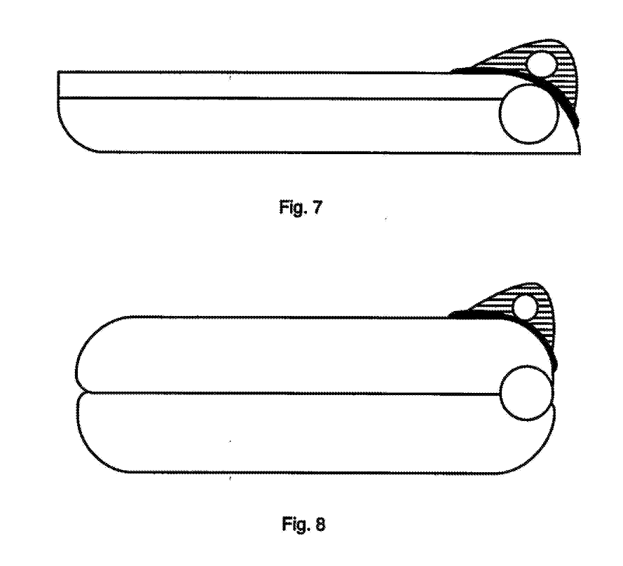

As seen in FIG. 6, FIG. 7, and FIG. 8, at least one of the innovative features of the technology herein is the ability to attach to curved surfaces with great strength. This is accomplished by decreasing the base in thickness as it approaches the edge of the attachment device, thus utilizing the maximum amount of attachment area. In at least one embodiment of the technology, as depicted in FIG. 2., the base does not go to the edge 201. Although this configuration is not the preferred embodiment, a person with ordinary skill in the art may use this base type for significantly the same purpose.

The flexibility here is accomplished by the use of molded soft PVC. Although not preferred, soft polymers may also be used for the same purpose to accomplish the same flexible result. Other polymers that can be used include synthetic rubber, bakelite, neoprene, nylon, polystyrene, polyethylene, polypropylene, polyacrylonitrile, PVB, silicone, combinations thereof and many more. Flexibility is important because most of the failures of today's attachment devices occur because of the curvature, or shape, of the mobile phones and gadgets. Any flat attachment ultimately fall-off or peels over time. Additionally, this increased flexibility allows the attachment device to be pliable and “give” to the tension of the external forces applied, as seen in FIG. 4. Furthermore, by contouring the attachment device 101 to the mobile device 601, as seen in FIG. 6., there is significantly less likelihood for detachment since the surface attachment area is increased significantly.

It was ingeniously found that when Polyvinyl Chloride (PVC) is blended with phthalate ester plasticizers, the PVC becomes soft and pliable, providing the useful flexibility needed for this application. PVC is similar in structure to polyethylene, but each unit contains a chlorine atom. The chlorine atom renders it vulnerable to some solvents, but also makes it more resistant in many applications. This particular vulnerability is ingeniously utilized for this application. A solvent-based adhesive breaks down the PVC, turning it into a loose solution, which will allow objects to be attached.

Another feature of the technology was the use of plastisol as a solvent-based adhesive 202. This solvent-based adhesive 202 creates an unbreakable adhesive bond between the attachment device 101 and the mobile gadget 601. Plastisol is a suspension of PVC particles in a plasticizer; it flows as a liquid and can be poured into a heated mold. When heated to around 177 degrees Celsius. The plastic and plasticizer mutually dissolve each other. A person skilled in the art may be use any solvent that dissolves PVC for the same purpose to obtain the same or similar result.

The PVC resins used in the inventive adhesives 202 were in suspension or emulsion polymerized products creating a plastisol. A plastisol is a 100% non-volatile liquid composition that is a physical mixture of finely sized PVC polymer particles and liquid plasticizers, such as phthalates and epoxidized oils. A heat stabilizer and an acid, such as a liquid epoxy resin, was included as part of the plastisol formulation. The remaining components of the plastisol solvent-based composition, according to the invention, comprise methylethylketone (MEK). A person skilled in the art may use other Ketones, or other PVC-solvents for the same purpose to obtain the same or similar result. Examples of Ketones are: diketones like biacetyl, unsaturated ketones like methyl vinyl ketone, and cyclic ketones generally in small quantities, such as dimethyl formamide.

Another feature of the inventive technology is that because plastisol is used as a solvent for the PVC adhesive, the surface of the mobile phone/device 501 dissolves 111. This 111 in turn creates a stronger bond. The cured solvent-based adhesive 202 is a soft, rubber-like material. Plastisols have the unique ability to absorb or bond through certain types of surface contaminants, such as mill oils, often found in metal substrates. This property, plus good economics and gap filling properties, result in the inventive use as a mobile device 501 attachment. The solvent-based adhesive according to the invention, as seen in FIGS. 11A, 11B, and 11C showed that the surface of the mobile device dissolved. Most of the mobile phone shells made today are made out of PVC or Molded Hard Polymers that dissolve 111 with the solvents used in the solvent-based adhesive 202. After drying this inventive feature becomes/transforms into a monolithic unbreakable structure FIG. 11C.

The application of the plastisol solvent-based adhesive, in mass production, is by brush, roll, bead, ribbon, or spray. Once the solvent-based adhesive 202 is applied, the solvents dissolve the surface of the mobile phone/device 501 and then evaporate, causing an increase in viscosity of the adhesive film. Bonds are made immediately after adhesive application, or after some solvent has evaporated, but before the adhesive has dried to the point where it will no longer wet. Waiting for some evaporation prior to bonding increases the initial strength of the solvent-based adhesive bond and allows assemblies to be processed more quickly. Drying time is a critical attribute for most adhesives, as is staying power. An adhesive that dries too quickly, before the attachment device can be attached properly, is a problem, as is an adhesive that takes too long to dry.

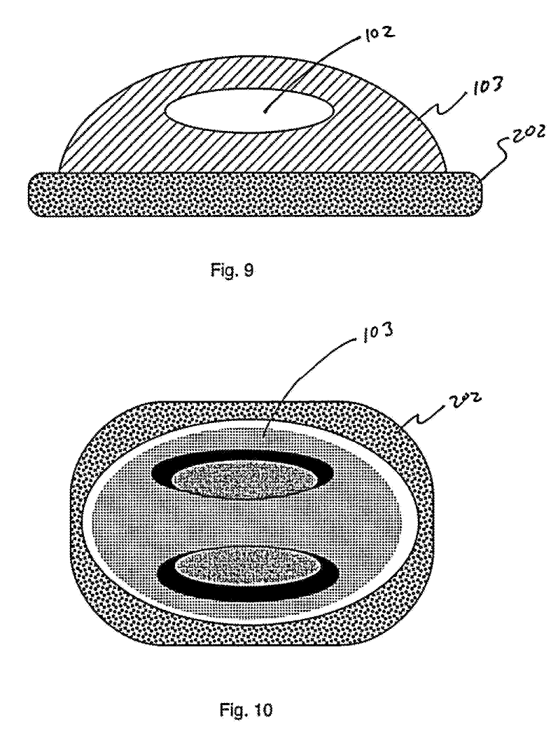

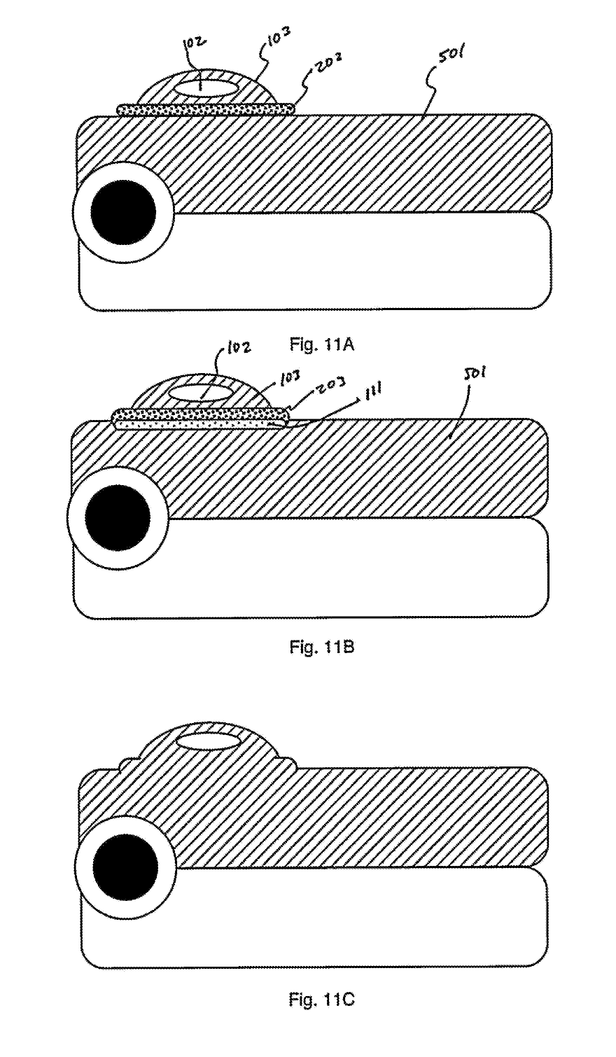

The inventive device herein solves the mentioned afore issues with mobile device attachments. By creating a monolithic structure bonded with the mobile device, as depicted in FIG. 11C, fatigue is prevented. Unlike other prior art attachments, there are few, if any, stress concentrations associated with adhesive joints with the inventive attachment device as seen in FIG. 11C. In one of the embodiments of the technology, as seen in FIG. 9, and FIG. 10, by increasing the surface area where the solvent-based adhesive is spread, the “joint stress” is distributed over a relatively large area. This provides a strong joint with lower specific stresses as the attached cord 401 is trying to pull away as seen in FIG. 4.

One of the inventive embodiments of the technology is that by using a solvent-based adhesive, the joint created provides a sealing function in addition to a fastening function. Furthermore, the application of said solvent-based adhesive in a high production process can be extremely economical compared to using other thermally cured glues or glue tape, since no high temperatures required for drying. Furthermore, since mobile gadgets/devices are weight sensitive, there is no weight penalty associated with adhesive joints, since the added weight is minimal.

Yet another advantage of the disclosed technology is that it prevents the stresses developed in a glued joint as seen in prior art devices. An adhesive joint is the ideal joint for permanently fastening two components together. Certain glues/glue tapes are vulnerable to attack by chemicals or water. Further, some glues/glue tapes require time to achieve design strength, and many glues/glue tapes have a temperature limitation. The biggest flaw with glues/glue tapes, now solved by the inventive technology, is that glues/glue tape joints are often vulnerable to localized high stress due to a peeling effect. In contrast, the disclosed solvent-based adhesive joint is not considered a joint, as the solvent-based adhesive becomes part of the external shell of the cellular phone, creating a monolithic bond.

It will be appreciated by those skilled in the art that changes could be made to the embodiments described above without departing from the broad inventive concept thereof. It is understood, therefore, that this technology is not limited to the particular embodiments disclosed, but it is intended to cover modifications within the spirit and scope of the present technology.

We claim:

1. An attachment device comprising:
at least one piece of elastic material, said at least one piece of elastic material defining the circumference at least one thru-cavity and at least one base, said at least; and
at least one solvent-based adhesive;
wherein said at least one base bonds to at least one mobile gadget's surface through said at least one solvent-based adhesive.

2. The device of claim 1, wherein said at least one thru-cavity engages and couples with at least one of the fasteners selected from the group consisting of, cords, metal rings, strings, thin ropes, hooks, chains, chain links and key-rings.

3. The device of claim 1, wherein the said at least one piece of elastic material is made of Polyvinyl Chloride (PVC) blended with phthalate ester plasticizers.

4. The device of claim 1, wherein the at least one solvent-based adhesive is plastisol.

5. The device of claim 1, wherein the said at least one piece of elastic material is selected from the group consisting of, synthetic rubber, bakelite, neoprene, nylon, polystyrene, polyethylene, polypropylene, polyacrylonitrile, PVB, silicone and polymer composites.

6. The device of claim 1, wherein the said at least one base together with said at least one solvent-based adhesive bonds and create a monolithic structure on a mobile gadget's surface.

7. The device of claim 1, wherein the said attachment device is used to secure mobile gadgets.

8. The device of claim 1, wherein the said attachment device is used to secure identifying charms.

9. A method to secure mobile gadgets comprising:
using at least one piece of elastic material, said at least one piece of elastic material defining the circumference at least one thru-cavity and at least one base;
mating said at least one base on to the surface of at least one mobile gadget; and
using at least one solvent-based adhesive to bond to at least one mobile gadget's surface creating a monolithic structure with said at least one base.

10. The method of claim 9, wherein said at least one thru-cavity that engages and couples with at least one of the fasteners selected from the group consisting of, cords, metal rings, strings, thin ropes, hooks, chains, chain links and key-rings.

11. The method of claim 9, wherein the said at least one piece of elastic material is made of Polyvinyl Chloride (PVC) blended with phthalate ester plasticizers.

12. The method of claim 9, wherein the said at least one solvent-based adhesive is plastisol and methylethylketone (MEK).

13. The method of claim 9, wherein the said at least one piece of elastic material is selected from the group consisting of, synthetic rubber, bakelite, neoprene, nylon, polystyrene, polyethylene, polypropylene, polyacrylonitrile, PVB, silicone and polymer composites.

14. The method of claim 9, wherein the said at least one base together with said at least one solvent-based adhesive bonds and create a monolithic structure on a mobile gadget's surface.

15. The method of claim 9, wherein the said device is used to secure identifying charms.
